(19) United States
(12) Patent Application Publication
(10) Pub. No.: US 2012/0216105 A1
(43) Pub. Date: Aug. 23, 2012

(54) SYSTEM AND METHOD FOR CREATING NON-FUNCTIONAL REQUIREMENTS FOR IMPLEMENTED TECHNOLOGY

(75) Inventors: Kailash Poddar, Coppell, TX (US); Meera Rao, Charlotte, NC (US)

(73) Assignee: Bank of America Corporation, Charlotte, NC (US)

(21) Appl. No.: 13/030,754

(22) Filed: Feb. 18, 2011

(51) Int. Cl. G06F 17/21

(52) U.S. Cl. 715/222

(57) ABSTRACT

A method can be used for creating a document associated with a technology to be implemented and containing at least one of the non-functional requirements required for the technology. The method utilizes a memory and a computer device in communication with the memory, as well as a framework tool that may be stored in the memory. The framework tool includes a plurality of non-functional requirement forms for use in creating a plurality of non-functional requirements. Each of the non-functional requirements is associated with one of the non-functional requirement forms. One or more of the non-functional requirement forms may require user input for completion to create the associated non-functional requirement. The document is created utilizing the computer device, by determining which of the non-functional requirements are required to be created for the technology, creating each required non-functional requirement, and adding each required non-functional requirement to the document.

### TECHNICAL FIELD

The invention relates to a system and method for creating and utilizing non-functional requirements in technology, and more specifically, to a system and method for defining and generating a non-functional requirements document and for using the document to create the non-functional requirements for new or modified technology.

### BACKGROUND

Documents such as business requirements documents (BRD's) are frequently used in the business world in implementing technologies, i.e., introducing new technologies (e.g., hardware/software) or modifying existing technologies. A BRD details the business solution for a project including the documentation of the needs and expectations of the client. A new BRD is typically created each time a new technology is implemented or an existing technology is modified. Among other things, BRD's typically contain a list of all functional requirements for the subject technology, to ensure that it will perform the necessary or desired functions and will operate properly with existing technologies. However, non-functional requirements (or quality requirements) are not typically included in BRD's, and the task of including non-functional requirements within a BRD presents certain difficulties. Some such difficulties are presented by the general lack of standardization, organization, and quick and easy access to non-functional requirements in institutional settings, as well as other settings. Other such drawbacks of the state of the art are recognized by those skilled in the art.

### BRIEF SUMMARY

The present systems and methods are provided to solve the problems discussed above and other problems, and to provide advantages and aspects not provided by prior systems and methods of this type.

Aspects of the present invention relate to a method for creating a business requirements document or other document associated with a technology to be implemented and containing at least one of the non-functional requirements that is required for the technology. The method utilizes a memory and a computer device in communication with the memory, as well as a framework tool that may be stored in the memory, where the framework tool includes a plurality of non-functional requirement forms for use in creating a plurality of non-functional requirements. Each of the non-functional requirements is associated with one of the non-functional requirement forms. One or more of the non-functional requirement forms may require user input for completion to create the associated non-functional requirement(s). The document is created utilizing the computer device, by determining which of the non-functional requirements are required to be created for the technology, creating each required non-functional requirement, and adding each required non-functional requirement to the document. The non-functional requirements are created using the non-functional requirement form associated with each required non-functional requirement, which may include adding user input to complete any non-functional requirement forms where user input is required. In one embodiment, at least some of the non-functional requirement forms have a plurality of options for selection to create the associated non-functional requirement, and creating the non-functional requirement may include selecting from the options for each non-functional requirement form that require or present options for selection. Additionally, the non-functional requirement forms may be standardized for all technologies that may be implemented.

According to one aspect, at least one of the non-functional requirement forms does not have options for selection to create each non-functional requirement associated with that non-functional requirement form.

According to another aspect, the options for selection in the non-functional requirement form may be a list of items. In this configuration, selecting from the options includes selecting one or more items from the list. Additionally, the options for selection in the non-functional requirement form may be a description having a blank, and selecting from the options includes entry of information in the blank.

According to a further aspect, the framework tool further includes a list of quality factors, each quality factor associated with one or more non-functional requirement forms. The quality factors each have a definition encompassing the non-functional requirement associated with each of the non-functional requirement forms associated with each quality factor.

According to yet another aspect, the framework tool further includes a requirement definition for each non-functional requirement form. Each requirement definition defines conditions under which the non-functional requirement associated with each non-functional requirement form is required to be created. In this configuration, determining which of the non-functional requirements are required to be created for the technology is performed based on the requirement definitions in the framework tool. At least one of the non-functional requirements may be required for all technologies and at least another one of the non-functional requirements may be required for technologies having a specified technological feature or characteristic.

According to a still further aspect, the framework tool is accessible through a web portal in communication with the computer device and accessible to a plurality of additional computer devices.

Additional aspects of the invention relate to a method that includes creating a framework tool using a computer device and storing the framework tool in memory in communication with the computer device, such that the memory and the framework tool are accessible to additional computer devices. Creating the framework tool includes recording a quality factor in the framework tool, the quality factor including a definition of the quality factor, and recording a non-functional requirement form for the quality factor, such that the non-functional requirement fits within the definition of the quality factor. The non-functional requirement form is configured for use in creating a non-functional requirement for a technology to be implemented. A requirement definition for the non-functional requirement form is also recorded. The requirement definition defines conditions under which the non-functional requirement associated with the non-functional requirement form is required to be created. These steps can be repeated for a plurality of additional quality factors to complete the framework tool.

According to one aspect, the non-functional requirement form requires addition of user input for completion to create the non-functional requirement. For example, the non-functional requirement form may have a plurality of options for selection for creating the non-functional requirement. The plurality of options may include a list of items for selection and/or a description having a blank for entry of information.

According to another aspect, the requirement definition may specify that the non-functional requirement is required for implementation of all technologies, or may specify that the non-functional requirement is required for technologies having a specified technological feature.

According to a further aspect, the framework tool is accessible to additional computer devices through a web portal in communication with the computer device and the memory.

According to yet another aspect, creating the framework tool further includes recording a unique identification code identifying the non-functional requirement form in the framework tool.

Further aspects of the invention relate to a system that includes a memory and a computer device in communication with the memory. The memory is configured for storing a framework tool that includes multiple non-functional requirement forms for use in creating non-functional requirements, as described above. Additionally, the computer device may be configured for performing all or part of the methods described above.

Still further aspects of the invention relate to a non-transitory computer-readable medium storing computer-readable instructions that, when executed by a computer device, cause the computer device to perform all or part of the methods described herein. The computer-readable instructions may also cause the computer device to provide a web portal for access to a plurality of additional computer devices, where the portal is configured to permit access to the framework tool for creating a document and/or a framework tool, as described above.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

To understand the present invention, it will now be described by way of example, with reference to the accompanying drawings in which:

FIG. 1 is a schematic diagram of one embodiment of a computer system;

FIG. 2 is a schematic view of one embodiment of a framework tool according to the present invention;

FIG. 3 is a flow diagram of one embodiment of a method for creating a framework tool according to the present invention; and

FIG. 4 is a flow diagram of one embodiment of a method for creating a document utilizing a framework tool according to the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a computer-readable medium may store computer-readable instructions (e.g., software) and/or computer-readable data (i.e., information that may or may not be executable). Any suitable computer readable media may be utilized, including various types of tangible and/or non-transitory computer readable storage media such as hard disks, CD-ROMs, optical storage devices, magnetic storage devices, and/or any combination thereof In addition, various signals representing data or events as described herein may be transferred between a source and a destination in the form of electromagnetic waves traveling through signal-conducting media such as metal wires, optical fibers, and/or wireless transmission media (e.g., air and/or space).

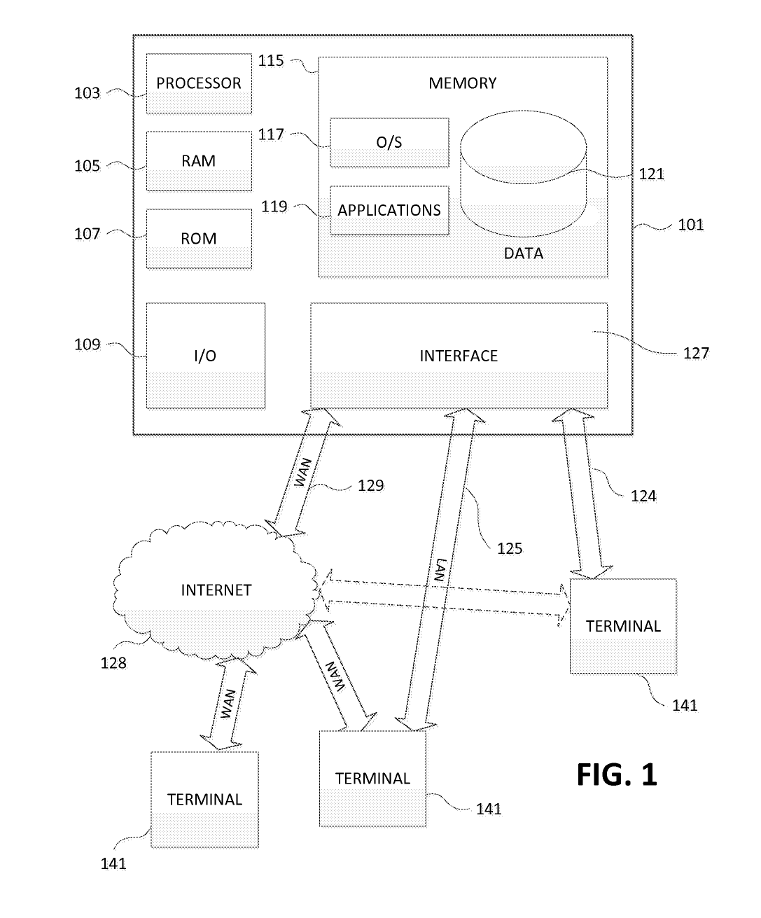

FIG. 1 illustrates a block diagram of a computer device or system 101 that may be used according to an illustrative embodiment of the invention. A “computer device” as referred to herein includes any electronic, electro-optical, and/or mechanical device, or system of physically separate such devices, that is able to process and manipulate information, such as in the form of data. Non-limiting examples of a computer device include one or more personal computers (e.g., desktop or laptop), servers, personal digital assistants (PDAs), ultra mobile personal computers, smart phones, cellular telephones, pagers, and/or a system of these in any combination. In addition, a given computer device may be physically located completely in one location or may be distributed among a plurality of locations (i.e., may implement distributive computing). A computer device may even be a mobile device. As such, any of the computer components or devices described herein, such as servers, browser devices, etc., may be embodied generally as shown in the computer device 101 of FIG. 1.

As shown in FIG. 1, the computer device 101 may have a processor 103 for controlling overall operation of the computer device 101 and its associated components, including RAM 105, ROM 107, input/output module 109, and memory 115. I/O 109 may include a user input device through which a user of computer 101 may provide input, such as a microphone, keypad, touch screen, mouse, and/or stylus, and may also include one or more of a speaker for providing audio output and a video display device for providing textual, audiovisual and/or graphical output.

Software may be stored within memory 115 and/or storage to provide instructions to processor 103 for enabling the computer device 101 to perform various functions, including functions relating to the methods described herein. For example, memory 115 may store software used by the computer device 101, such as an operating system 117, application programs 119, and an associated database 121. Alternatively, some or all of the computer executable instructions may be embodied in hardware or firmware (not shown). It is understood that a computer device 101, single processor 103, and single memory 115 are shown and described for sake of simplicity, and that the computer device 101, processor 103, and memory 115 may include a plurality of computer systems, processors, and memories respectively.

The computer device 101 may be configured to operate in a networked environment supporting connections to one or more other computers, such as terminals 141. The terminals 141 may be personal computers, servers, or any other computer device, and may include many or all of the elements described above relative to the computer device 101. The network connections depicted in FIG. 1 include a wide area network (WAN) 129, but may also include other networks, such as a local area network (LAN) 125. When used in a LAN networking environment, the computer device 101 is connected to the LAN 125 through a network interface or adapter 123. When used in a WAN networking environment, the computer 101 may include a modem 127 or other means for establishing communications over the WAN 129, such as the Internet 128. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program or programs 119 used by the computer device 101 according to an illustrative embodiment of the invention may include computer executable instructions for invoking user functionality related to communication, such as email, data messaging (e.g., short message service (SMS), MMS, etc.), and voice input and speech recognition applications.

In general, aspects of the invention relate to a framework tool containing forms for creating non-functional requirements, and which may also be used in identifying one or more non-functional requirements necessary for implementing software, hardware, and/or other technology. Non-functional requirements (NFRs), which may also be referred to as quality requirements, are requirements that specify criteria and/or goals that can be used to judge the operation of a system, a group of systems, a part of a system, or even a single transaction or group of transactions. These NFRs establish design requirements and constraints on building the appropriate level of quality in a system. Aspects of the invention also relate to systems and methods for creating or modifying such a framework tool and/or utilizing such a framework tool in creating a document associated with a technology to be implemented, for example a business requirements document (BRD) or the like.

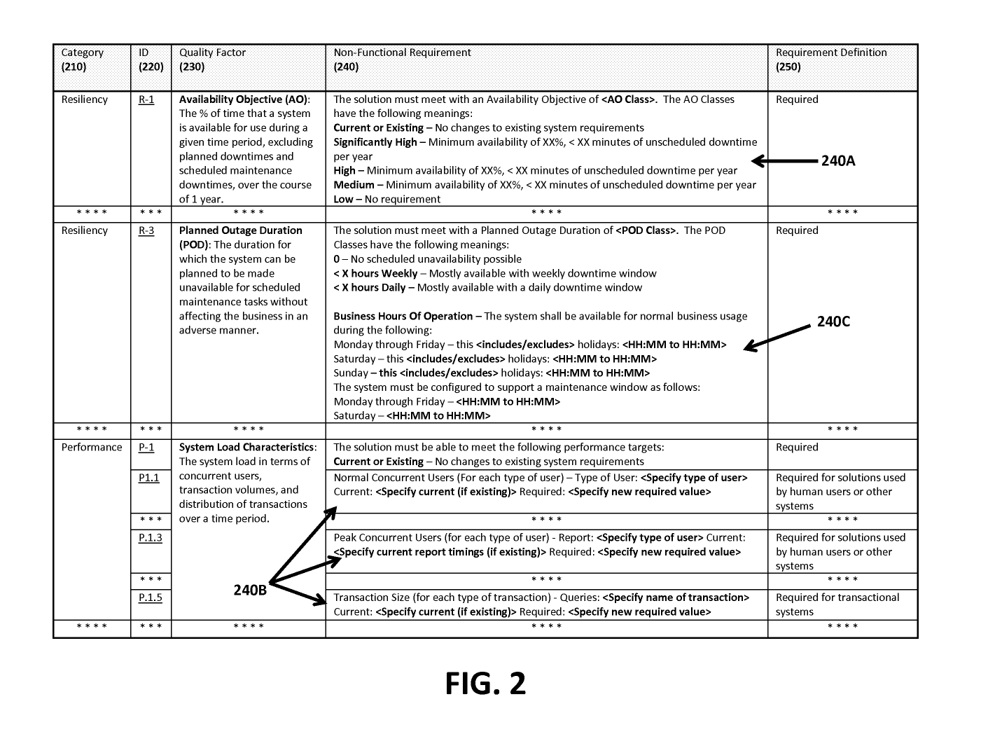

FIG. 2 illustrates an example embodiment of a framework tool 200, in the form of a spreadsheet document that may be stored in memory 115 of a computer device 101. In general, the framework tool 200 includes fields for categories 210, identification codes 220, quality factors 230, NFR forms 240, and applicability or requirement definitions 250. It is understood that the framework tool 200 may contain more information than shown in FIG. 2, and the asterisks (* * *) in the framework tool 200 indicate areas where subject matter in the framework tool 200 may be omitted from FIG. 2 for the sake of brevity. It is also understood that the framework tool 200 may include additional fields not shown in FIG. 2. Additionally, in other embodiments, the fields may include additional information or types of information and/or may have certain information or types of information omitted.

The quality factors 230 and/or the NFR forms 240 may be categorized into a number of different categories 210. In one embodiment, the framework tool 200 utilizes quality factors in at least one or more of a number of specified categories, which are listed below along with general descriptions of the types of quality factors 230 and NFRs that may fall under such categories 210:
Resiliency: Ability to avoid failures, minimize the effects and recover from a fault while meeting a specified degree of availability.
Performance: Ability to perform functional tasks in timely fashion under stated conditions of load and data volumes.
Scalability: Ability to maintain acceptable performance under stated conditions of increase in load and data volumes.
Security: Ability to ensure that information is accessible only to those who are authorized (confidentiality), safeguard the accuracy and completeness of information and processing methods from unauthorized intentional or accidental changes (data integrity), and ensure that the authorized users have access to information and associated assets when required (availability).
Usability: Ability to enable users to accomplish tasks efficiently, and to discover and learn system functionality easily within regulatory requirements and geographical requirements.
Supportability: Ability to maintain the operational status by way of monitoring health of the environment and ensuring that changes can be installed and problems can be easily identified and resolved.
Maintainability: Ability to modify to correct defects, improve performance or other attributes, or adapt to changes in the environment or business needs due to market, regulations, offerings, technology, etc., including aspects such as testability, extensibility, modularity, and portability.
Interoperability: Ability to integrate and interoperate with other systems.
Regulatory Compliance: Ability to comply with applicable laws and regulations.

In one embodiment, each of these categories 210 is utilized, and the framework tool 200 organizes each of the quality factors 230 and NFR forms 240 under one of these categories 210. It is understood that additional or fewer categories 210 may be used in other embodiments, and that the categories 210 may be more broadly or narrowly defined. The framework tool 200 may not use categories 210 in another embodiment.

In the embodiment of FIG. 2, the framework tool 200 includes identification codes 220 that are unique to each NFR form 240. The identification codes 220 may be alphanumeric, as shown in FIG. 2, or may take a different form. Additionally, as also shown in FIG. 2, the identification codes may contain some indication of the category 210 into which the respective NFR form 240 has been placed. As described in greater detail below, the identification codes 220 may provide utility in referencing the framework tool 200 through external sources, such as through reference to another document (which may include linking to the other document).

The quality factors 230 each have one or more NFR forms 240 associated therewith, and generally describe the subject matter of the NFR form(s) 240 that are associated with each quality factor 230. In the embodiment shown in FIG. 2, each quality factor 230 includes a title (bolded) and a definition defining and encompassing the associated NFRs and the type(s) of constraints and/or requirements the associated NFR(s) will place on the system. In another embodiment, the framework tool 200 may not include a separate field for quality factors 230, and may include some or all of the quality factor information into another field, such as the field for NFR forms 240, or may omit such information.

The NFR forms 240 provide a template or guide for creation of NFRs for a particular technology, based on the characteristics of the technology. In one embodiment, all of the NFR forms 240 are standardized in the framework tool 200 for all technologies that may be implemented, permitting institutional control over the NFRs and consistency in NFRs throughout an institution. Additionally, in one embodiment, an institution may utilize the framework tool 200 in a comprehensive manner, such that the framework tool 200 includes NFR forms 240 for all or nearly all NFRs that any person or entity in the institution may need to use for technology implementation. One or more NFRs can be derived from a single NFR form 240, and at least some of the NFR forms 240 require a user to complete the NFR form 240 in order to create the NFR(s). As illustrated in FIG. 2, the NFR forms 240 may have different configurations depending on the nature of the associated quality factor 230, among other things. Additionally, at least one of the NFR forms 240 requires user input for completion to create the associated NFR. For example, at least some of the NFR forms 240 may have one or more options for selection to create the associated NFR. Such options may be presented in the form of a list of items for selection or a description with a blank for filling in appropriate information, as well as other types of selectable options. Such a list of items for selection may require selection of only one item or may permit or require selection of multiple items, as appropriate. The user input may also include deleting subject matter from the NFR form 240 that is extraneous, unnecessary, or not applicable. It is noted that the term “X” or “XX” in the framework tool 200 is intended to illustrate a specified quantity that is not shown in FIG. 2, but which would be specified in the framework tool 200, as opposed to blanks for entry of information, which are denoted by “<>”. For example, in the first NFR form 240A, “XX %” may refer to “99.5%” or “98%” or any appropriate availability percentage, which would be specified in the framework tool 200.

In the embodiment of FIG. 2, a first type of NFR form 240A is utilized for the quality factor of “Availability Objective” in FIG. 2. The first NFR form 240A presents options for selection in the form of a list of items. In this embodiment, the items in the list of the first NFR form 240A are quality classes including “Significantly High,” “High,” “Medium,” “Low,” and “Current or Existing.” Each of these quality classes is defined in the framework tool 200, and it is understood that the minimum availability % would typically decrease, with the permissible minutes of downtime per year increasing, as the options progress from Significantly High to Low. In completing the NFR form 240A to create a NFR, a user would select one of the quality classes and insert the selected quality class in the blank identified by “<AO Class>”. After this action, the NFR form 240 would then be considered to be completed to form a NFR, which can be utilized as desired, such as by inserting into a BRD or other document.

The embodiment of the framework tool 200 in FIG. 2 also includes a second type of NFR form 240B, which is utilized for the quality factor of “System Load Characteristics.” The second NFR form 240B presents options for selection in the form of blanks for entry of information, denoted by “<>” in FIG. 2. For example, the NFR form 240B for “Normal Concurrent Users” requires the entry of the type of user, the current number of normal concurrent users (if existing), and the required number of normal concurrent users. After entry of this information, the NFR form 240B has been completed to form a NFR. Additionally, the NFR form 240B for “Normal Concurrent Users” can be used to create multiple NFRs, as the NFR form 240B requires that it must be completed to form separate NFRs for each different type of user involved in the technology to be implemented. The NFR forms 240 for “Peak Concurrent Users” and “Transaction Size” likewise require different NFRs for different types. It is noted that several NFR forms 240B are associated with the quality factor 230 for “System Load Characteristics,” and that the NFR forms 240B have different requirement definitions 250, as described below.

The embodiment of the framework tool 200 in FIG. 2 also includes a third type of NFR form 240C, which is utilized for the quality factor of “Planned Outage Duration.” The third NFR form 240C presents options for selection in the form of a list of items and also in the form of blanks for entry of information, denoted by “<>” in FIG. 2. Completion of the third NFR form 240C requires selecting one of the quality classes from the list, inserting the selected quality class in the blank identified by “<POD Class>”, and entry of the required information in all of the “<includes/excludes>” blanks and the “<HH:MM>” blanks (referring to entry of clock times).

It is understood that additional or alternate types of NFR forms 240 may be used in this and other embodiments. For example, one or more of the NFR forms 240 may not require any information for completion, and may be utilized directly from the framework tool 200 without alteration or further work.

The requirement definitions 250 define conditions under which specific NFRs are applicable to a specific technology and/or must be described in a BRD or other document associated with such technology. In the embodiment of the framework tool 200 illustrated in FIG. 2, each NFR form 240 has a requirement definition 250 associated therewith, indicating the conditions or criteria under which the NFR form 240 must be completed for use in a BRD. The conditions or criteria in the requirements definitions 250 may be dependent on the nature or characteristics of the technology to be implemented and/or other factors. As shown in FIG. 2, some of the NFR forms 240 are required for any technology to be implemented (i.e. the NFR forms 240 for “Planned Outage Duration” and “Availability Objective”). Other NFR forms 240 are required only in certain situations, such as for technologies with one or more specified technological features. For example, the “Normal Concurrent Users” and “Peak Concurrent Users” NFR forms 240 are required only for solutions used by human users or other systems, and the “Transaction Size” NFR form 240 is required only for transactional systems. It is understood that the requirement definitions 250 may be defined in any suitable manner for each NFR form 240 and/or quality factor 230.

As described above, the framework tool 200 may include additional fields not shown in FIG. 2. For example, the framework tool 200 may include a priority indication, such as an indication of how critical or essential a particular NFR or quality factor 230 is, based on desired criteria. As another example, the framework tool 200 may include further information identifying the fields or linking the framework tool 200 to other documents and systems. Further, in one embodiment, the framework tool 200 may include hidden, embedded, or other information that is not presented to the user in text form, which may include at least some of the information in the fields discussed above. For example, the identification code 220 may not be presented directly to the user. As another example, the requirement definitions 250 may not be presented directly to the user, such as in an embodiment where the requirement definitions 250 are evaluated by a computer device 101 to determine which NFRs are required, as discussed below herein. Still further examples are contemplated.

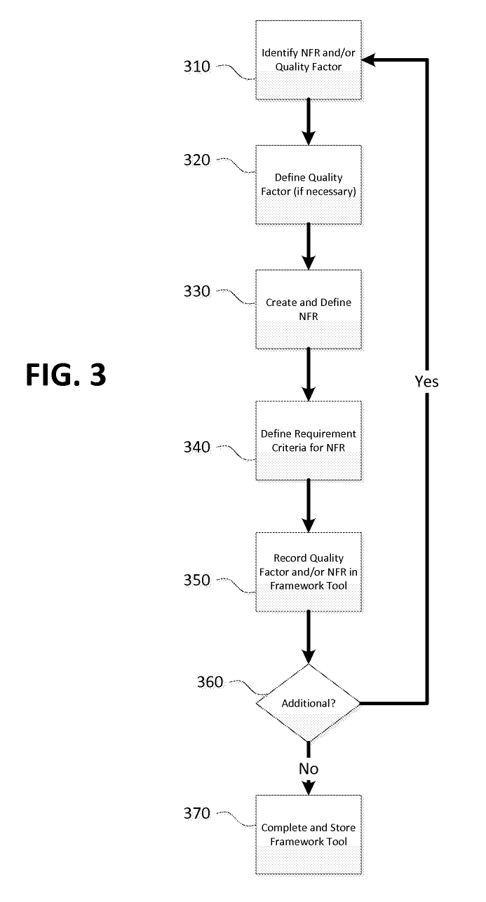

FIG. 3 illustrates an example embodiment of a method 300 for creating a framework tool or revising or modifying an existing framework tool, such as the framework tool 200 illustrated in FIG. 2. At step 310, a quality factor 230 and/or NFR form 240 to be added is identified. It is noted that special clearance or permission may be required to add quality factors 230 or NFR forms 240, and if such clearance or permission is required, it may be obtained at step 310. If a quality factor 230 is to be added or revised, the quality factor is defined at step 320. Defining the quality factor 230 may include creating a name for the quality factor 230, a description or definition of the quality factor 230, and/or adding further information.

At step 330, one or more NFR forms 240 are created and defined, including associating the NFR form(s) with a quality factor 230 and adding any options for selection to complete the NFR form(s) 240. In one embodiment of the framework tool 200, each quality factor 230 includes at least one NFR associated therewith and fitting within the definition of the quality factor 230. In this embodiment, if a quality factor 230 is created, then one or more NFR forms 240 are created and defined at step 330. Additionally, a NFR form 240 may be added to the framework tool 200 without creating a new quality factor 230, such as by associating the NFR form 240 with an existing quality factor 230. In that case, the method proceeds directly from step 310 to step 330. The criteria for the requirement definition 250 for each created NFR form 240 is defined at step 340. Further information may also be created or associated with the quality factor 230 and/or NFR form(s) 240, such as a category 210, identification 220, or various other types of information.

The quality factor 230 (if applicable), as well as the associated NFR form(s) 240 and requirement definition(s) 250, which are created and defined in steps 310-340, are recorded in the framework tool 200 at step 350. In one embodiment, where the framework tool 200 is in the form of a spreadsheet, recording this information can be performed by entering the information in the appropriate fields and locations in the spreadsheet and storing the spreadsheet in memory. It is understood that recording this information may be done at any time, including progressively as each piece of information is created, retroactively at the end of the method 300, or at another time. Additionally, recording any and all of this information may include receiving user input at a computer device 101.

If one or more additional quality factors 230 and/or NFR forms 240 are to be created or revised, the method 300 proceeds back to step 310, as noted in step 360. If no more quality factors 230 and/or NFR forms 240 are to be created or revised, the method 300 proceeds to step 370, as also noted in step 360. At step 370, the framework tool 200 is completed by adding any other necessary information and is stored in memory for access as necessary to utilize the framework tool 200. The method 300 may be used to modify an existing framework tool 200 or create and build a new framework tool 200, such as by repetition of steps 310-360 until the modification, creation, and/or building is complete.

The framework tool 200 can be provided for access through a web portal, which can enhance accessibility and ease of use for users of the framework tool 200. The web portal may be configured to permit access to the framework tool 200 by approved users, and may also be configured to permit access to modify the framework tool 200 by users with sufficient clearance or permission.

Additional documents and other tools can be created in connection with the framework tool 200. For example, a document may be provided that lists affiliated persons or group for each quality factor 230 and/or NFR form 240. In one embodiment, the affiliated persons or groups may be persons or groups who have interest in each quality factor 230 and/or NFR form 240. In another embodiment, the affiliated persons or groups may be persons or groups who have influence over or responsibility for each quality factor 230 and/or NFR form 240, including persons or groups who must be consulted for modification or addition. In a further embodiment, one or more of the quality factors 230 and/or NFR forms 240 may be accessible to only a limited number of users, and the affiliated persons or groups may be persons or groups who are provided such limited access. Such documents/tools can be provided for access through the web portal along with the framework tool 200. Additionally, such documents/tools may be interlinked with the framework tool 200 for easy access. In one embodiment, the identification codes 220 in the framework tool 200 function as web links that can transfer the user between the framework tool and one or more other related documents. Still further options and variations are contemplated.

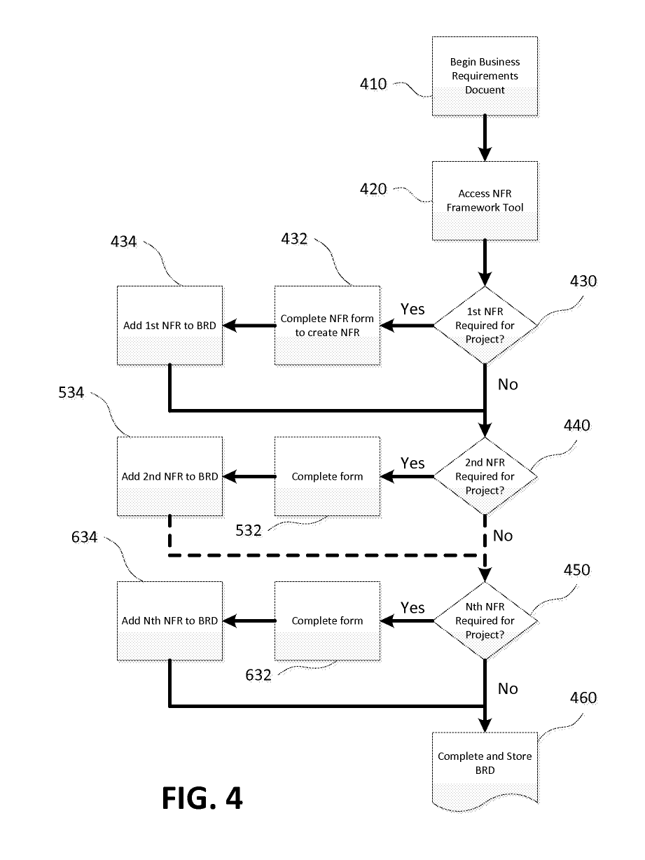

FIG. 4 illustrates a method 400 of utilizing a framework tool, such as the framework tool 200 shown in FIG. 2, in creation or modification of a BRD or other document associated with a technology to be implemented. The BRD is begun at step 410, and the framework tool 200 may be accessed for use in building the BRD at step 420 when desired, such as when the NFRs are to be added to the BRD. The framework tool 200 may be accessed through a web portal, as described above, and may be interlinked with other documents/tools for access and use in creating the BRD.

The various NFR forms 240 in the framework tool 200 are evaluated at steps 430-450, to determine which NFRs are required to be created and included in the BRD for the technology. This determination may include a computer device 101 providing an indication of which NFRs are required for a particular technology, which can be accomplished through providing access to the framework tool 200 with the requirement definitions 250 for each NFR form 240 associated with the NFRs. Determining which NFRs are required may include consulting the requirement definitions 250 associated with each NFR form 240 in the framework tool 200 to determine if the technology meets the criteria specified in each requirement definition 250. This determination may be made manually in one embodiment, which may utilize a computer device 101 to access the framework tool 200. In another embodiment, the determination may be made automatically by a computing device 101, such as by compiling a list of all requirements necessary for the technology depending on features and characteristics of the technology. Making an automatic determination may involve requesting and receiving user input, such as by presenting a questionnaire to a user for gathering information related to the technology, and then applying the user input to the requirement definitions 250 to make the determination.

For each required NFR, the associated NFR form 240 is used to create the NFR, at steps 432, 442, and 452. Creating each NFR may include completion of the associated NFR form 240, which in turn may include receiving user input that is added to any NFR forms 240 where it is required, such as by receiving a selection of one or more options for any NFR form 240 that requires options for selection. As described above, selecting from the options may include selecting one or more items from a provided list and/or entry of information in a provided blank, as well as other actions.

After a required NFR is created, the NFR can be added to the BRD, at steps 434, 444, and 454. This can be performed by different techniques, including “copy and paste.” It is understood that each created NFR may be added to the BRD in any way, including adding individually after creation, or adding a group of created NFRs together. For example, the NFR can be created and added to the BRD simultaneously, by “pasting” the NFR form into the BRD and then receiving user input as may be required to complete the NFR. Additional information can be added to the BRD as well, such as the quality factor 230 associated with each required NFR and the corresponding definition in the quality factor 230, the category of each NFR, the names of affiliated persons or groups, and/or further information as desired. After all required NFRs are added, the BRD may be completed and stored, at step 460. Completion of the BRD may include addition of other information that may or may not be related to the NFRs. The BRD may be stored in memory that may be accessible to appropriate users.

As stated above, FIGS. 2-4 illustrate examples of one or more aspects of systems and methods for creating, modifying, and using a framework tool 200 containing NFRs, such as for creating a BRD or other document. The steps of the methods described above can be accomplished by means and/or components contained within the computer device 101, such as the memory 115, processor 103, and/or program modules and computer-executable instructions stored therein or executed thereby, and may also be accomplished by non-computer means, such as by IT personnel or forensic investigators, or by a combination of human and computerized components. Other components of the computer device 101 may also constitute means for accomplishing aspects of the present invention, as understood by those skilled in the art. It is understood that one entity or computer system may not perform each and every aspect of the present invention and that aspects may be outsourced to one or more other entities.

Aspects of the present invention are operational with numerous other general purpose or special purpose computing system environments or configurations, such as the computer device 101 shown in FIG. 1. Examples of well known computing systems, environments, and/or configurations that may be suitable for use with the present invention include, but are not limited to, the various types of computer devices described above, including personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As also described above, aspects of the present invention may be described in the general context of computer-executable instructions, such as program modules, being executed by a computer. In one embodiment, at least some aspects of the present invention may be performed by a web browser application on a browser device. Generally, program modules include routines, programs, objects, components, data structures, etc. that perform particular tasks or implement particular abstract data types. The present invention may also be practiced in distributed computing environments where tasks are performed by remote processing devices that are linked through a communications network. In a distributed computing environment, program modules may be located in the memory 115, which may include both local and remote computer storage media including memory storage devices. It is understood that connections and communications disclosed herein may be made by any type of wired or wireless connection or communication.

Aspects of the present invention provide many benefits not provided by prior systems and methods for processing user information. For example, the systems and methods described herein allow for more effective organization of and access to non-functional requirements, facilitating their use in various projects and for various purposes. As another example, the framework tool provides greater control over the definitions of non-functional requirements, allowing for standardization and greater institutional consistency. As a further example, the framework tool makes identification of non-functional requirements for implementing a particular technology easier and quicker. This, in turn, facilitates the creation of business requirements documents and other such documents in connection with implementing a technology. As yet another example, the use of the web portal further enhances accessibility of the framework tool and the non-functional requirements. Still other benefits and advantages exist and are apparent to those skilled in the art.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is further understood that the invention may be in other specific forms without departing from the spirit or central characteristics thereof The present examples therefore are to be considered in all respects as illustrative and not restrictive, and the invention is not to be limited to the details given herein. The term “plurality,” as used herein, indicates any number greater than one, either disjunctively or conjunctively, as necessary, up to an infinite number. Accordingly, while the specific examples have been illustrated and described, numerous modifications come to mind without significantly departing from the spirit of the invention and the scope of protection is only limited by the scope of the accompanying claims.

What is claimed is:

1. A computer-assisted method comprising:
storing, in memory, a framework tool comprising a plurality of non-functional requirement forms for use in creating a plurality of non-functional requirements, wherein each of the non-functional requirements is associated with one of the non-functional requirement forms, and at least one of the non-functional requirement forms requires user input for completion to create the respective non-functional requirement; and
creating a document, using a computer device in communication with the memory, the document being associated with a technology to be implemented and containing one or more of the plurality of non-functional requirements that are required for the technology, wherein creating the document comprises:
providing an indication of which of the non-functional requirements are required for the technology, wherein the indication is configured for use in determining one or more required non-functional requirements;
creating each required non-functional requirement using the non-functional requirement form associated with each required non-functional requirement, including receiving user input to complete the at least one non-functional requirement form that requires user input; and
adding each required non-functional requirement to the document.

2. The method of claim 1, wherein the at least one non-functional requirement form requiring user input has a plurality of options for selection, and receiving user input comprises receiving a user selection from the options to complete the at least one non-functional requirement form.

3. The method of claim 2, wherein at least one of the non-functional requirement forms does not have options for selection to create each non-functional requirement associated with each of the at least one non-functional requirement forms.

4. The method of claim 2, wherein a first non-functional requirement form has options for selection comprising a list of items, and receiving the user selection from the options includes receiving a selection of one or more items from the list, and wherein a second non-functional requirement form has options for selection comprising a description having a blank, and receiving the user selection from the options includes receiving entry of information in the blank.

5. The method of claim 1, wherein the framework tool further comprises a list of quality factors, each quality factor associated with one or more non-functional requirement forms, wherein the quality factors each have a definition encompassing the non-functional requirement associated with each of the one or more non-functional requirement forms associated with each quality factor.

6. The method of claim 1, wherein the framework tool further comprises a requirement definition for each non-functional requirement form, each requirement definition defining conditions under which the non-functional requirement associated with each non-functional requirement form is required to be created, and wherein the requirement definitions in the framework tool are configured for use in determining the one or more required non-functional requirements.

7. The method of claim 1, wherein at least one of the non-functional requirements is required for all technologies and at least another one of the non-functional requirements is required for technologies having a specified technological feature.

8. The method of claim 1, wherein the framework tool is accessible through a web portal in communication with the computer device and accessible to a plurality of additional computer devices.

9. The method of claim 1, further comprising automatically determining the one or more required non-functional requirements.

10. The method of claim 9, further comprising presenting a questionnaire for input of information related to the technology by the user and receiving input of the information related to the technology in response to the questionnaire, and wherein determining the one or more required non-functional requirements is performed based on the information related to the technology.

11. The method of claim 1, wherein the non-functional requirement forms are standardized for all technologies that may be implemented.

12. A system comprising:
a memory storing a framework tool comprising a plurality of non-functional requirement forms for use in creating a plurality of non-functional requirements, wherein each of the non-functional requirements is associated with one of the non-functional requirement forms, and wherein at least one of the non-functional requirement forms requires user input for completion to create the respective non-functional requirement; and
a computer device in communication with the memory, the computer device configured for performing:
creating a document associated with a technology to be implemented and containing at least one of the non-functional requirements required for the technology, wherein creating the document comprises:
providing an indication of which of the non-functional requirements are required for the technology, wherein the indication is configured for use in determining one or more required non-functional requirements;
creating each required non-functional requirement using the non-functional requirement form associated with each required non-functional requirement, including receiving user input to complete the at least one non-functional requirement form that requires user input; and
adding each required non-functional requirement to the document.

13. The system of claim 12, wherein the at least one non-functional requirement form requiring user input has a plurality of options for selection, and receiving user input comprises receiving a user selection from the options to complete the at least one non-functional requirement form.

14. The system of claim 13, wherein a first non-functional requirement form has options for selection comprising a list of items, and receiving the user selection from the options includes receiving a selection of one or more items from the list, and wherein a second non-functional requirement form has options for selection comprising a description having a blank, and receiving the user selection from the options includes receiving entry of information in the blank.

15. The system of claim 12, wherein the framework tool further comprises a requirement definition for each non-functional requirement form, each requirement definition defining conditions under which the non-functional requirement associated with each non-functional requirement form is required to be created, and wherein determining which of the non-functional requirements are required to be created for the technology is performed based on the requirement definitions in the framework tool.

16. The system of claim 12, wherein at least one of the non-functional requirements is required for all technologies and at least another one of the non-functional requirements is required for technologies having a specified technological feature.

17. A non-transitory computer-readable medium storing computer-readable instructions that, when executed by a computer device, cause the computer device to perform:
storing, in memory, a framework tool comprising a plurality of non-functional requirement forms for use in creating a plurality of non-functional requirements, wherein each of the non-functional requirements is associated with one of the non-functional requirement forms, and at least one of the non-functional requirement forms requires user input for completion to create the respective non-functional requirement; and
providing a web portal for access to a plurality of additional computer devices, wherein the portal is configured to permit access to the framework tool for creating a document, using one of the additional computer devices, the document being associated with a technology to be implemented and containing at least one of the non-functional requirements required for the technology, wherein creating the document comprises:
providing an indication of which of the non-functional requirements are required for the technology, wherein the indication is configured for use in determining one or more required non-functional requirements;
creating each required non-functional requirement using the non-functional requirement form associated with each required non-functional requirement, including receiving user input to complete the at least one non-functional requirement form that requires user input; and
adding each required non-functional requirement to the document.

18. The computer-readable medium of claim 17, wherein the at least one non-functional requirement form requiring user input has a plurality of options for selection, and receiving user input comprises receiving a user selection from the options to complete the at least one non-functional requirement form.

19. The computer-readable medium of claim 18, wherein a first non-functional requirement form has options for selection comprising a list of items, and receiving the user selection from the options includes receiving a selection of one or more items from the list, and wherein a second non-functional requirement form has options for selection comprising a description having a blank, and receiving the user selection from the options includes receiving entry of information in the blank.

20. The computer-readable medium of claim 17, wherein the framework tool further comprises a requirement definition for each non-functional requirement form, each requirement definition defining conditions under which the non-functional requirement associated with each non-functional requirement form is required to be created, and wherein determining which of the non-functional requirements are required to be created for the technology is performed based on the requirement definitions in the framework tool.

21. The computer-readable medium of claim 17, wherein at least one of the non-functional requirements is required for all technologies and at least another one of the non-functional requirements is required for technologies having a specified technological feature.

22. A computer-assisted method comprising:
creating a framework tool, using a computer device, comprising:
(a) recording a quality factor in the framework tool, the quality factor including a definition of the quality factor,
(b) recording a non-functional requirement form for the quality factor, the non-functional requirement form configured for use in creating a non-functional requirement for a technology to be implemented, wherein the non-functional requirement fits within the definition of the quality factor,
(c) recording a requirement definition for the non-functional requirement form, the requirement definition defining conditions under which the non-functional requirement associated with the non-functional requirement form is required to be created, and
(d) repeating (a)-(c) for each of a plurality of additional quality factors; and
storing the framework tool in memory in communication with the computer device, wherein the memory and the framework tool are accessible to a plurality of additional computer devices.

23. The method of claim 22, wherein the non-functional requirement form has a plurality of options for selection for creating the non-functional requirement.

24. The method of claim 23, wherein the plurality of options comprises at least one of a list of items for selection and a description having a blank for entry of information.

25. The method of claim 22, wherein the non-functional requirement form requires addition of user input for completion to create the non-functional requirement.

26. The method of claim 22, wherein the requirement definition specifies that the non-functional requirement is required for implementation of all technologies.

27. The method of claim 22, wherein the requirement definition specifies that the non-functional requirement is required for technologies having a specified technological feature.

28. The method of claim 22, wherein the framework tool is accessible to the plurality of additional computer devices through a web portal in communication with the computer device and the memory.

29. The method of claim 22, wherein creating the framework tool further comprises:
recording a unique identification code identifying the non-functional requirement form in the framework tool.

30. A system comprising:
a computer device configured for creating a framework tool by performing
(a) recording a quality factor in the framework tool, the quality factor including a definition of the quality factor,
(b) recording a non-functional requirement form for the quality factor, the non-functional requirement form configured for use in creating a non-functional requirement for a technology to be implemented, wherein the non-functional requirement fits within the definition of the quality factor,
(c) recording a requirement definition for the non-functional requirement form, the requirement definition defining conditions under which the non-functional requirement associated with the non-functional requirement form is required to be created, and
(d) repeating (a)-(c) for each of a plurality of additional quality factors; and
a memory in communication with the computer device, the memory storing the framework tool, wherein the memory and the framework tool are accessible to a plurality of additional computer devices.

31. The system of claim 30, wherein the non-functional requirement form requires addition of user input for completion to create the non-functional requirement.

32. The system of claim 30, wherein the requirement definition specifies that the non-functional requirement is required for implementation of all technologies.

33. The system of claim 30, wherein the requirement definition specifies that the non-functional requirement is required for technologies having a specified technological feature.

34. The system of claim 30, wherein creating the framework tool further comprises:
recording a unique identification code identifying the non-functional requirement form in the framework tool.

35. A non-transitory computer-readable medium storing computer-readable instructions that, when executed by a computer device, cause the computer device to perform:
creating a framework tool, comprising:
(a) recording a quality factor in the framework tool, the quality factor including a definition of the quality factor,
(b) recording a non-functional requirement form for the quality factor, the non-functional requirement form configured for use in creating a non-functional requirement for a technology to be implemented, wherein the non-functional requirement fits within the definition of the quality factor,
(c) recording a requirement definition for the non-functional requirement form, the requirement definition defining conditions under which the non-functional requirement associated with the non-functional requirement form is required to be created, and
(d) repeating (a)-(c) for each of a plurality of additional quality factors; and
storing the framework tool in memory in communication with the computer device, wherein the memory and the framework tool are accessible to a plurality of additional computer devices.

36. The computer-readable medium of claim 35, wherein the non-functional requirement form requires addition of user input for completion to create the non-functional requirement.

37. The computer-readable medium of claim 35, wherein the requirement definition specifies that the non-functional requirement is required for implementation of all technologies.

38. The computer-readable medium of claim 35, wherein the requirement definition specifies that the non-functional requirement is required for technologies having a specified technological feature.

39. The computer-readable medium of claim 35, wherein the creating the framework tool further comprises:
recording a unique identification code identifying the non-functional requirement form in the framework tool.
